(19) United States
(12) Patent Application Publication
(10) Pub. No.: US 2003/0195956 A1
(43) Pub. Date: Oct. 16, 2003

(54) System and method for allocating unique zone membership

(75) Inventors: Walter Bramhall, Houston, TX (US); Ruotao Huang, Mountain View, CA (US)

Correspondence Address: BAKER BOTTS, LLP, 910 LOUISIANA, HOUSTON, TX, 77002-4995, US

(73) Assignee: MaXXan Systems, Inc.

(21) Appl. No.: 10/122,759

(22) Filed: Apr. 15, 2002

(51) Int. Cl. G06F 15/173

(52) U.S. Cl. 709/223

(57) ABSTRACT

The present disclosure describes a method and apparatus for ensuring the unique zoning membership representation in a network environment. In one aspect, the members of a container may be evaluated to determine whether any are subordinate to or children of a target member of the same container. The subordinate or child members may be removed from the container's configuration. Generally following the removal of any subordinate or child members of the target member, a determination may be made as to whether the target member is a child of or subordinate to any container members remaining in the container's configuration. If the target member is determined to be subordinate to or a child of a remaining container member, the target member may be removed from the container's configuration. Consequently, redundant member entries, unintentional communication paths and the complexities associated with creating a zoning configuration may be avoided.

### CROSS-REFERENCE TO RELATED APPLICATIONS

This application is related to U.S. patent application Ser. No. 09/738,960, entitled “Caching System and Method for a Network Storage System” by Lin-Sheng Chiou, Mike Witkowski, Hawkins Yao, Cheh-Suei Yang, and Sompong Paul Olarig, which was filed on Dec. 14, 2000 and which is incorporated herein by reference in its entirety for all purposes; U.S. patent application Ser. No. 10/015,047 [attorney docket number 069099.0102/B2] entitled “System, Apparatus and Method for Address Forwarding for a Computer Network” by Hawkins Yao, Cheh-Suei Yang, Richard Gunlock, Michael L. Witkowski, and Sompong Paul Olarig, which was filed on Oct. 26, 2001 and which is incorporated herein by reference in its entirety for all purposes; U.S. patent application Ser. No. 10/039,190 [attorney docket number 069099.0105/B5] entitled “Network Processor Interface System” by Sompong Paul Olarig, Mark Lyndon Oelke, and John E. Jenne, which was filed on Dec. 31, 2001, and which is incorporated herein by reference in its entirety for all purposes; U.S. patent application Ser. No. 10/039,189 [attorney docket number 069099.0106/B6-A] entitled “Xon/Xoff Flow Control for Computer Network” by Hawkins Yao, John E. Jenne, and Mark Lyndon Oelke, which was filed on Dec. 31, 2001, and which is incorporated herein by reference in its entirety for all purposes; U.S. patent application Ser. No. 10/039,184 [attorney docket number 069099.0107/B6-B] entitled “Buffer to Buffer Flow Control for Computer Network” by John E. Jenne, Mark Lyndon Oelke and Sompong Paul Olarig, which was filed on Dec. 31, 2001, and which is incorporated herein by reference in its entirety for all purposes; U.S. patent application Ser. No. ______ [attorney docket number 069099.0109/(client reference 115-02)], entitled “System and Method for Linking a Plurality of Network Switches,” by Ram Ganesan Iyer, Hawkins Yao and Michael Witkowski, which was filed Apr. 5, 2002 and which is incorporated herein by reference in its entirety for all purposes; U.S. patent application Ser. No. ______ [attorney docket number 069099.0111/(client reference 135-02)], entitled “System and Method for Expansion of Computer Network Switching System Without Disruption Thereof,” by Mark Lyndon Oelke, John E. Jenne, Sompong Paul Olarig, Gary Benedict Kotzur and Matthew John Schumacher, which was filed Apr. 5, 2002 and which is incorporated herein by reference in its entirety for all purposes; U.S. patent application Ser. No. ______ [attorney docket number 069099.0112/(client reference 220-02)], entitled “System and Method for Guaranteed Link Layer Flow Control,” by Hani Ajus and Chung Dai, which was filed Apr. 5, 2002 and which is incorporated herein by reference in its entirety for all purposes; U.S. patent application Ser. No. ______ [attorney docket number 069099.0113/(client reference 145-02)], entitled Fibre Channel Implementation Using Network Processors,” by Hawkins Yao, Richard Gunlock and Po-Wei Tan, which was filed Apr. 5, 2002 and which is incorporated herein by reference in its entirety for all purposes; and U.S. patent application Ser. No. ______ [attorney docket number 069099.0114/(client reference 230-02)], entitled “Method and System for Reduced Distributed Event Handling in a Network Environment,” by Ruotao Huang and Ram Ganesan Iyer, which was filed Apr. 5, 2002 and which is incorporated herein by reference in its entirety for all purposes.

### BACKGROUND OF THE INVENTION TECHNOLOGY

1. Field of the Invention

The present application is related to computer networks. More specifically, the present application is related to a system and method for ensuring inadvertent device duplication in the zones or alias groups of network zoning configurations.

2. Description of the Related Art

Current Storage Area Networks (“SANs”) are designed to carry block storage traffic over predominantly Fibre Channel (“FC”) standard media and protocols. FC SANs are local networks that are generally equivalent to the many common types of local area networks (“LANs”) used in standard data communications networks. Expansion of SANs is limited in that conventional FC SANs cannot generally be implemented over geographically distant locations. Conventional FC architecture is not suitable for most wide area networks (“WANs”) or metropolitan area network configurations. While TCP/IP and Ethernet may be used to implement block storage protocols over a WAN/LAN, these two protocols are not efficient solutions for block storage applications. Accordingly, current SANs are generally limited to a single geographic location.

Zoning (or logical partitioning) is a software technique for managing and controlling access to devices connected to a SAN. Zoning typically enables network administrators to group devices by limiting the access to the devices. As such, zoning provides an efficient means for managing, partitioning and controlling access to devices in a SAN and enables heterogeneous devices to be grouped by operating system or other common operational characteristics.

Despite the many advantages of SANs and of zoning technology, an easily identifiable but, as of yet, unresolved problem in their use is the difficulty associated with their implementation. Inexperienced and experienced network personnel alike often mistakenly configure zones by specifying the same device more than once, inadvertently creating connections between zones which are intended to be isolated, and/or unnecessarily specifying child nodes or ports of an included parent device or ports included in a given zone configuration, among other mistakes.

### SUMMARY OF THE INVENTION

The present invention remedies the shortcomings of the prior art by providing a system and method for promoting container members to the most general zoning participant that includes the container member.

In one aspect, the present invention provides a method for ensuring unique container membership. The method preferably includes determining whether a parent-child relationship exists between a current member and a target member of the container and removing each child member from a container configuration in response to the existence of a parent-child relationship between the current member and the target member.

In a further aspect, the present invention provides a computing device having at least one processor, memory operably coupled to the processor, a communication interface operably coupled to the memory and the processor and a program of instructions storable in the memory and executable by the processor, where the program of instructions is operable to identify any subordinate members in a container and to remove the subordinate members from a container configuration.

The present invention provides the technical advantage of minimizing the risk of unintentional communication path openings between containers in various zones and members of the containers.

The present invention further provides the technical advantage of reducing many of the complexities associated with implementing a zoning configuration in a SAN.

The present invention provides the additional technical advantage of preventing or eliminating the inclusion of a zoning participant in a zoning configuration where the parent of the zoning participant is already a member of a zoning container in the zoning configuration.

The present invention also provides the technical advantage of protecting a client from specifying multiple entries for a zoning participant in a zone or alias group by promoting zone or alias group members to the most general zoning participant that includes the sub-member.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a block diagram illustrating an arrangement of nodes, zones, and other items in a switch fabric, according to the teachings of the present invention.

FIG. 1a is a block diagram illustrating an alternate arrangement of nodes, node zones, and other items in a switch fabric, according to the teachings of the present invention.

FIG. 2 is a flowchart illustrating an exemplary embodiment of a method for promoting container members according to the teachings of the present invention.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are also covered by the claims.

### DETAILED DESCRIPTION OF SPECIFIC EMBODIMENTS

The present invention is directed to a storage network device that performs a multiplicity of functions and has a multiplicity of port types to allow it to connect to a variety of network types (e.g., Fibre Channel, Gigabit Ethernet, etc.). A primary function of the invention is to act as a storage network switch wherein frames are switched from port to port. However, because of its architecture, the present invention has the ability to perform many additional functions that take advantage of its high performance, highly scalable, and highly programmable infrastructure. The method of the present invention includes a method for implementing a zoning functionality that supports the client specification of a zone or alias group member in a number of situations.

There are two main types of zoning for purposes of the present invention: switch port-based zoning and device-based zoning. Switch port-based zoning includes a method for configuring switch ports to make up one or more zones. Zone enforcement is applied regardless of what device is connected to the port. Switch port-based zoning generally allows or disallows routing between specific switch ports depending on whether or not the ports are configured into the same zone. Switch ports generally can be configured into a zone regardless of whether or not a device is connected to the port.

Device-based zoning is a zoning method where specific devices or host bus adapters (“HBA's”) are employed to define one or more zones. The implication of the device-based zoning technique is that zoning is enforced for a particular Fibre Channel device, regardless of which switch port the device is connected to, or whether the device is moved from one switch port to another or even to another switch on the fabric.

The present invention contemplates allowing a client to specify the precise zoning participant in any of the following ways. For example, the client would be allowed to specify zoning participants by Device Port World-Wide Name, Switch Port Number and Domain Identifier (“ID”), Device Node World-Wide Name or Device Port Address Identifier.

In general, defining zoning participants using the Device Port World-Wide Name naming methodology enables the specified device port, i.e., the device port identified by the World-Wide Name, to be accessible to other members within the same zone. Further, moving a particular device port from the switch port to which it is currently connected to another switch port on a managed switch within the same SAN does not change the zone or alias group membership of that device port.

In the Switch Port Number and Domain ID zoning participant identification methodology, device ports connected to a switch port identified in a zoning configuration using the switch port's Switch Port Number and Domain ID will generally be available to other members in the same zone. This form of zoning participant selection and identification is transient in nature, i.e., changing the device connected to the switch port will typically result in a different device being available to the remaining zone participants or members.

The zoning specification methodology based on Device Node World-Wide Names generally results in the accessibility of all ports on the particular device node identified by its World-Wide Name by the other members of the zone. The addition or removal of ports to the device node in turn add or remove ports from the accessible member pool defined by the zone. Moving the device node to a different switch port, in general, will not affect the accessibility of the device node's ports to other zone members.

A zoning specification methodology based on a Device Port Address Identifier generally results in the device port with the specified address identifier, typically assigned during the fabric login, to be accessible by other members in the zone. As a device port is not always assigned the same address identifier during consecutive fabric logins, this method may not be a reliable way to ensure that a certain device port is always accessible to other zone members. Additional methods of assigning devices or portions thereof to zones may be used with the teachings of the present invention.

Allowing this much flexibility in the manner in which zoning participants may be specified generally increases the probability that the same device will be entered into a zoning configuration using different specification approaches or through the specification of a device and a “parent” of the same device. Accordingly, the present invention is directed to reducing the likelihood of having multiple entries for the same zoning participant in a zone or alias group by promoting each zone and alias group member to the most general zoning participant including the sub-member.

According to teachings of the present invention, operations associated with promoting each zone or alias group member to the most general zoning participant including the sub-member may be embodied in software that is storable in a memory and executable by a processor, or hardwired into an application-specific integrated circuit (“ASIC”), or some combination thereof. In general, a device that is operable to incorporate the teachings of the present invention includes at least one processor, and a memory and communication interface coupled to the processor (not expressly shown). Examples of such devices include, but are not limited to, servers, mainframes, laptops, switches, routers, bridges, hubs, application blades or the like. In an embodiment employing a plurality of devices, the various devices may include like devices or a variety of different devices.

In an exemplary embodiment, the zone-participant promotion policy of the present invention may be embodied in one or more application blades, where an application blade may be defined as any electronic device operable to perform one or more functions. For example, an application blade may be a peripheral card connected to a server or other device coupled to a switch. Other examples of application blades include, but are not limited to: remote computing devices communicatively coupled to a communication network by a network connection; software processes running virtually on a single or multiprocessing system and/or single or multithreading processor; electronic appliances with specific functionality; or the like.

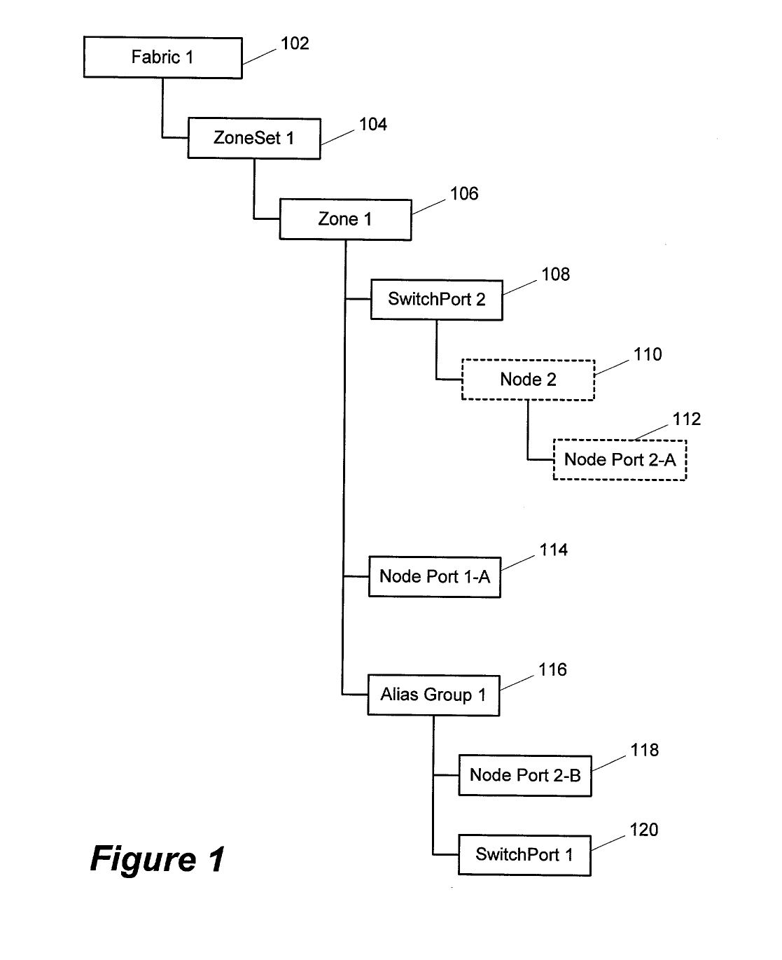

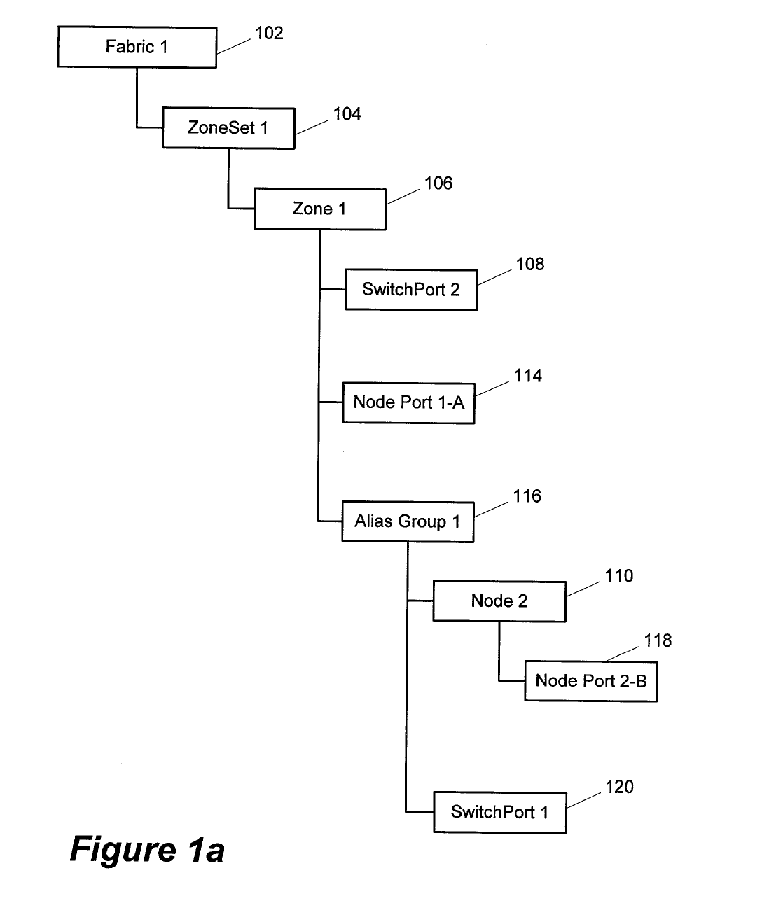

Illustrated generally in FIG. 1 is a zoning configuration containing a plurality of zoning participants for a given fabric. Specifically, FIG. 1 illustrates the fabric 102 having the single zone set 104. A zone set may be defined as a group of zones that can be enabled or disabled together. A device member may be included in more than one zone.

The zone set 104 includes the single zone 106, as illustrated. A zone typically includes two or more ports. Multiple devices can access each other through port-to-port connections. Devices that are accessible in the same zone can see and communicate with each other, but those same devices are not intended to communicate with devices that are made accessible to other zones.

The zone 106 includes three members, the switch port 108, the node port 114 and the alias group 116. An alias group is a logical collection of, for example, switch ports, devices/nodes, and/or node ports (“zone participants”) that are grouped together. The zone participants are grouped together in order to associate a name (the “alias”) with the group so that the group can be added to, or removed from, the zone, en masse, by name. As illustrated in FIG. 1, the node 110 and the node port 112 are shown merely to indicate their parent-child/subordinate relationship with to the switch port 108. The alias group 116 has two members, the node port 118 and the switch port 120. Teachings of the present invention may be employed with various fabric, zone set, zone, alias group and sub-member configurations. As such, FIG. 1 is but one possible configuration of zoning participants that may benefit from teachings disclosed herein.

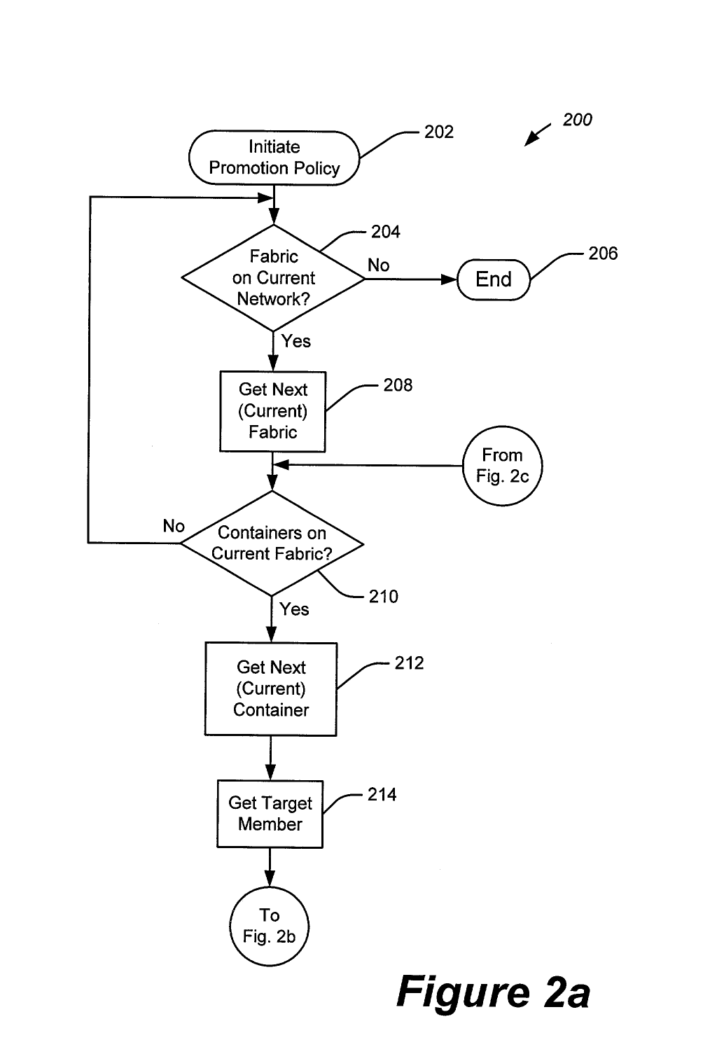

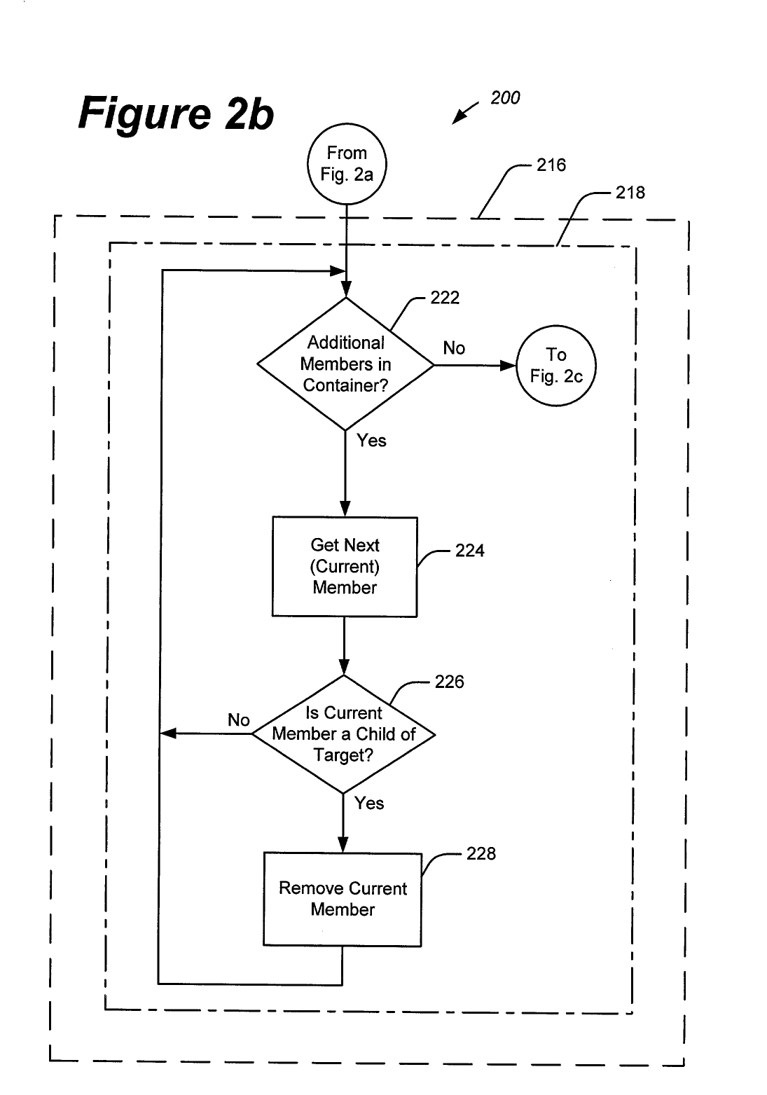

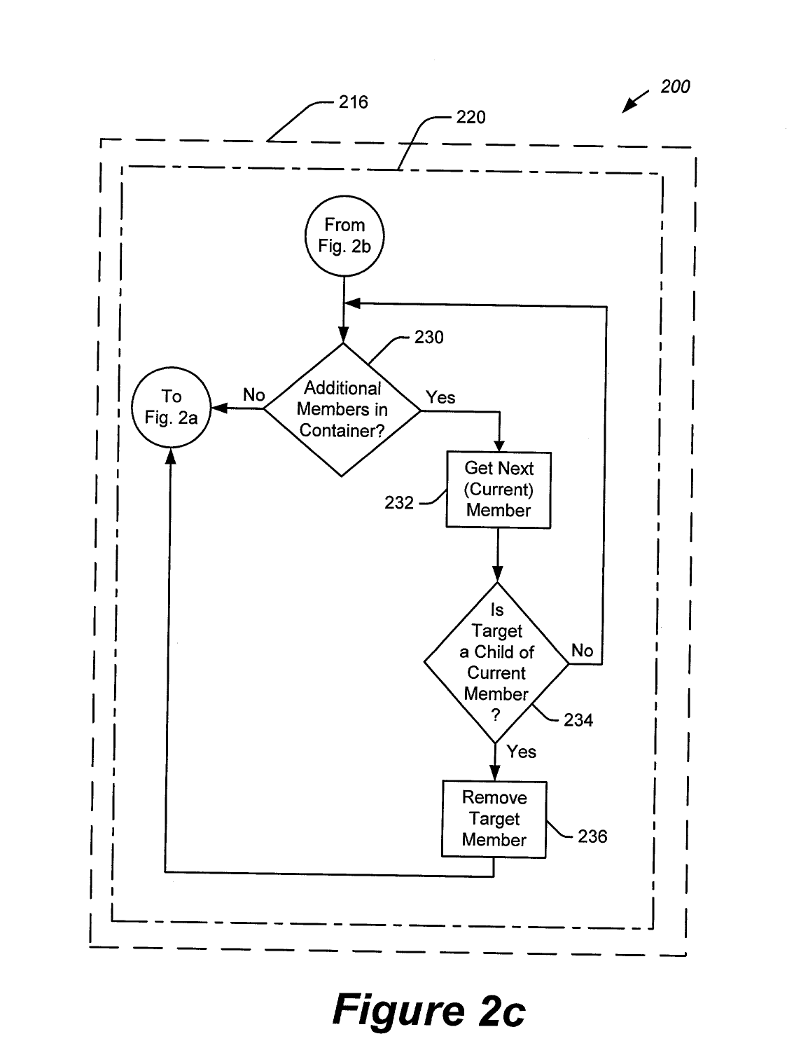

As an operating example of the present invention, assume one was to add the node 110 to the alias group 116 and that the node port 118 is the child port of the node 110, as illustrated in FIG. 1a. The promotion policy of the present invention or the method 200, as illustrated in FIG. 2, will preferably recognize the parent-child relationship between the node port 118 and the node 110, remove the node port 118 from the zoning configuration for the alias group 116, and add the node 110 as a new member of the zoning configuration for the alias group 116 as demonstrated illustratively in FIGS. 1 and 1a. The zoning configuration for a fabric may be stored in a file by a zoning sever on the network, for example, or otherwise made available to various network management or general network devices.

Another benefit of the promotion policy of the present invention is its ability to prevent or eliminate the inclusion of a zoning participant whose parent is already a member of a zoning container, e.g., a zone set, zone, alias group, etc. For example, referring back to FIG. 1, assume an attempt is made to add the node 110 to the zone 106 (recall that node 110 is displayed in FIG. 1 only to show its associations of membership with the switch port 108). The promotion policy embodied in method 200 will preferably recognize that the node 110, as well as the node port 112 of the node 110 is connected to the switch port 108 that is already a member of the zone 106, i.e., the parent of the node 110 and the node part 112, namely the switch port 108, is already a member of the container or zone 106. Such recognition and elimination by method 200 will generally not change the zoning configuration that is illustrated in FIG. 1. Method 200 will be described in detail below with reference to FIG. 2.

Illustrated in FIGS. 2a-2c is a flow diagram depicting one method of a device promotion policy incorporating teachings of the present invention. In general, method 200 of the present invention preferably performs two (2) scans on each member of each container, e.g., zone or alias group, returned in a zoning configuration from a zoning server. However, in an alternate embodiment of the present invention, the promotion policy may be applied when changes are made to the zoning configuration by a client device, rather than the zoning server. In the latter embodiment, the promotion policy is applied before the new zoning configuration is returned to the zoning server for application to the network switches zoning repository (where the zoning configurations are stored for reference by the network switches).

In an exemplary embodiment, the first scan 218, referred to herein as Scan-A, preferably determines if any of the container members is a child of or is subordinate to the member being checked or a target member. If it is determined that a container member is a child of, or is subordinate to, the member being checked, the child member is preferably deleted from the zoning configuration for the container. The second scan 220, referred to herein as Scan-B, preferably determines whether the member being checked is a child of, or is subordinate to, any of the container members remaining after processing by the Scan-A 218. If the current member that is being checked or processed is found to be a child of, or subordinate to, another container member, the target or current member is preferably deleted from the zoning configuration for the container currently being reviewed. In operation of method 200, the Scan-B 220 preferably iterates until either a relationship between the two members being evaluated is identified, or until the membership of the current container is exhausted. Additional iterations of the Scan-B 220 are generally not required.

The method 200 may be initiated at step 202. According to teachings of the present invention, the method 200 may be initiated or executed at the direction of a network administrator, in response to changes in an associated network, in response to changes in one or more zoning configurations, or in response to other triggers. At step 202, the network may be interrogated for its current zoning configuration. For example, a zoning server, or other network management device, may be interrogated by method 200 for a current layout or configuration of the zones on the network, e.g., an arrangement of devices, fabrics, zone sets, zones, alias groups, etc. Alternatively, method 200 may implement its own network interrogation routine that is operable to return such zoning configuration information to a process that implements the method for use as described herein.

Attention is directed to FIG. 2a, where upon initiation at step 202, method 200 preferably proceeds to step 204. At step 204, method 200 may interrogate the zoning configuration of the current network to determine whether there exist one or more fabrics that may benefit from the promotion policy of the present invention. If, at step 204, it is determined there are no fabrics incorporated into the current network or the current network is not using zoning, method 200 may end at 206 or be altered such that method 200 proceeds to another network for investigation. Alternatively, if at step 204, it is determined there are one or more fabrics present or implemented on the current network, method 200 may proceed to step 208.

At step 208, the next fabric that has not been processed by the promotion routine 216 in the present instance or the configuration or makeup of the next fabric may be obtained. For purposes of description, the next fabric becomes the current fabric being subjected to the promotion policy of the present invention. Again, method 200 may initiate its own fabric configuration discovery routine to determine the contents, structure or configuration of the current fabric, or method 200 may request such information from one or more network management resources likely to have such information. Once the configuration of the current fabric has been obtained at step 208, method 200 may proceed to step 210.

At step 210, the configuration of the current fabric is preferably reviewed to determine whether the current fabric includes one or more containers that have not been processed by the promotion routine 216. As mentioned above, containers may include, but are not limited to, alias groups, zone sets and zones. In a further embodiment, an individual step designed to check the current fabric for the presence of the various possible types of containers may be included in method 200.

If at step 210 it is determined the current fabric does not include any containers, or that all of the current fabric's containers have been processed by the promote routine 216 on the present occasion, method 200 preferably returns to step 204, where the current zoning configuration is again reviewed for a determination as to whether there are any additional fabrics on the current network that have not been subjected to the promotion policy of the present invention. If, at step 210, it is determined that there exists additional, unprocessed containers in the current fabric, method 200 may proceed to step 212 where the next container of the current fabric is preferably obtained and becomes the new current container.

Once the next container in the zoning configuration has been obtained, method 200 may proceed to step 214, where a target member from the current container is preferably obtained. According to the teachings of the present invention, the target member may be selected according to a variety of rules. For example, the target member of the current container may be selected at random, according to a network address, port number, device type, etc. Once selected, the target member is preferably maintained throughout the execution of the promote routine 216 of the present invention, i.e., steps 222 through 236 (see FIGS. 2b and 2c). Upon selection of a target member at step 214, method 200 may proceed to step 222 of FIG. 2b.

As illustrated in FIG. 2b, at step 222 a check is made to determine whether the current container contains additional members or contains members that have not been processed by the Scan-A 218, i.e., steps 222 through 228. If at step 222 it is determined there are no more members remaining in the current container or that all of the members in the current container have been subjected to the Scan-A 218, method 200 preferably proceeds to step 230 of FIG. 2c. The details of step 230 will be discussed in greater detail below. Alternatively, if, at step 222, it is determined that the current container contains additional members, or that the current container includes members that have not been processed by the Scan-A 218, method 200 preferably proceeds to step 224 where the next member of the current container is preferably obtained and becomes the current member.

Using the target member obtained at step 214 and the next or current member obtained at step 224, the Scan-A 218 of method 200 may determine whether there is a relationship between the target and current members at step 226. At step 226 of the Scan-A 218, method 200 preferably determines whether the current member is a child of, or is subordinate to, the target member. If at step 226 it is determined that the current member is not a child of, or subordinate to, the target member, method 200 may return to step 222 where the current container is again reviewed for a determination whether there exists any remaining members which have not been subjected to the Scan-A 218.

In addition to checking for a parent-child or subordinate relationship between the target member and the current member of the current container, the promote routine 216 may include a check that is designed to determine if the target member and the current member are redundant members or entries representative of a like device. Such a step may be implemented in the Scan-A 218 between the steps 224 and 226, in the Scan-B 220 between the steps 232 and 234 (see FIG. 2c) or in both the Scan-A 218 and the Scan-B 220, for example. Alternatively, the steps 226 and 234 of the Scan-A 218 and the Scan-B 220, respectively, may be modified to further determine whether there is any redundancy between the target member and the current member.

To effect the desired promotion of the various members, if at step 226 it is determined that the current member is a child of, or is subordinate to, the target member, method 200 preferably proceeds to step 228. At step 228 the current member may be deleted from the current container's configuration in the zoning configuration for the current network. Upon deletion of the current child or subordinate member at step 228, method 200 preferably returns to step 222 where the current container is again reviewed for a determination as to whether there exists any remaining members that have not been subjected to the Scan-A 218.

The Scan-A 218, that is to say, the steps 222 through 228, is preferably repeated for all members of the current container. Once all of the members of the current container have been subjected to the Scan-A 218, method 200 preferably proceeds from step 222 to step 230, or the Scan-B 220 that is illustrated in FIG. 2c.

Referring to FIG. 2c, in general, steps 230 through 236 may be defined as the Scan-B 220, the second scan to be performed according to teachings of the present invention. The Scan-B 220 need only be repeated until either a relationship is identified between the target member and the next or current member that is being evaluated, or until all members of the current container have been exhausted, processed, or otherwise checked.

Beginning at step 230, the Scan-B 220 generally begins by determining whether the current container contains any members remaining after the Scan-A 218 processing, or whether any container members remain which have not been subjected to the Scan-B 220. If at step 230, it is determined that there are no additional or remaining members in the current container, such as by the Scan-A 218, effecting the deletion of all members other than the target member, method 200 preferably returns to step 210 (see FIG. 2a) where the current fabric is again reviewed for a determination as to whether there exist any additional containers that have not been subjected to, or processed, the promote routine 216 of the present invention, as described above.

Alternatively, if at step 230 it is determined container members remain after the processing of the Scan-A 218, method 200 preferably proceeds to step 232. At step 232, the next member that remains in the container may be obtained and become the current member. Once the next or current member is obtained at step 232, method 200 preferably proceeds to step 234.

At step 234, method 200 may determine whether the target member is a child of, or subordinate to, the current member under evaluation. If it is determined that the target member is a child of, or subordinate to, the current member at step 234, the target member is preferably deleted from the configuration for the current container at step 236. From step 236, method 200 preferably returns to step 210 where the current fabric is again reviewed for a determination as to whether there exists any containers that have not been subjected to or processed by the promote routine 216 (see FIG. 2a).

Alternatively, if at step 234 it is determined that the target member is not a child of the current member, method 200 preferably returns to step 230. As mentioned above, at step 230 the current container is again reviewed for a determination as to whether there are any remaining members or additional members that haven't been subjected to the Scan-B 220. As mentioned above, either once a relationship between the target member and the current member is identified at step 234, or all members of the current container have been processed by the Scan-B 220 as determined at step 230, then the method 200 preferably returns to step 204 (see FIG. 2a) to ensure the entire zoning configuration for the current network has been processed.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited by only the spirit and scope of the appended claims, giving full cognizance to equivalents in all respects.

What is claimed is:

1. A method for allocating unique container membership comprising:
determining whether a parent-child relationship exists between a current member and a target member of the container; and
removing each child member from a container configuration in response to the existence of a parent-child relationship between the current member and the target member.

2. The method of claim 1 wherein the step of determining further comprises:
determining whether the current member is a child member of the target member; and
determining whether the target member is a child member of any container members remaining after removal of all child members of the target member.

3. The method of claim 1 further comprising:
determining whether both the current member and the target member represent a single container member; and
removing one of the members from the container configuration in response to the single container member being represented by both the target member and the current member.

4. The method of claim 1 further comprising selecting the target member from the members of the container.

5. The method of claim 1 further comprising repeating the determining and removing steps for each container on a network fabric.

6. The method of claim 5 further comprising repeating the determining and removing steps for each fabric in a network.

7. A method for promoting container members within a container configuration comprising:
removing a container member from the container configuration in response to a determination that the container member is subordinate to a target member; and
removing the target member from the container configuration in response to a determination that the target member is subordinate to another container member.

8. The method of claim 7 further comprising removing the container member from the container configuration in response to a determination that the target member and the container member indicate a like device.

9. The method of claim 7 further comprising repeating the removing the container member step until all members of a current container have been evaluated for subordination to the target member.

10. The method of claim 7 further comprising the repeating the removing the target member step until the first to occur of a subordinate relationship determination or the target member has been evaluated for subordination to all members of a current container.

11. The method of claim 7 further comprising repeating both of the removing steps for each container included in a fabric selected from a zoning configuration on a storage area network.

12. A method for representing members in a container configuration comprising:
selecting a fabric from a network;
selecting a container from the fabric;
selecting a target member from the container, the container having a corresponding container configuration;
for each additional member in the container, determining whether the member is a child member of the target member;
removing child members from the container configuration;
determining whether the target member is a child member of any members remaining in the container; and
removing the target member from the container configuration in response to a determination that the target member is a child member.

13. The method of claim 12 further comprising removing from the container configuration each member which represents a like device to a device represented by the target member.

14. The method of claim 12 further comprising repeating the determining whether the target member is a child member step and the removing the target membership until the members remaining in the container gave been exhausted or a parent to the target member has been identified, whichever is first.

15. A computing device comprising:
at least one processor;
memory operably coupled to the processor;
a communication interface operably coupled to the memory and the processor; and
a program of instructions storable in the memory and executable by the processor, the program of instructions operable to identify any subordinate members in a container and remove the subordinate members from a configuration for the container.

16. The computing device of claim 15 further comprising the program of instructions operable to first determine whether each member in the container is subordinate to a target member selected from the container.

17. The computing device of claim 16 further comprising the program instructions operable to second determine whether the target member is subordinate to any members remaining in the container.
